(19) United States
(12) Patent Application Publication
(10) Pub. No.: US 2004/0233936 A1
(43) Pub. Date: Nov. 25, 2004

(54) Apparatus for generating a control signal of a target beacon transmission time and method for the same

(76) Inventor: Sheng-Yuan Cheng, Jhubei City (TW)

Correspondence Address: SEYFARTH SHAW, 55 EAST MONROE STREET, SUITE 4200, CHICAGO, IL, 60603-5803, US

(21) Appl. No.: 10/655,111

(22) Filed: Sep. 2, 2003

(30) Foreign Application Priority Data
May 21, 2003 (TW) 092113764

(51) Int. Cl. H04J 3/06

(52) U.S. Cl. 370/509; 370/338; 370/350

(57) ABSTRACT

The revealed apparatus is electrically connected to a host, which activates the apparatus by setting a predetermined target beacon transmission time (TBTT), for generating the control signals of the TBTT. The apparatus comprises a timing synchronization timer, a comparator electrically connected to the timing synchronization timer, and an adder electrically connected to the comparator. The comparator compares the time of the timing synchronization timer and the predetermined TBTT, and generates the control signals of the TBTT if the comparison result is true. When the comparator generates the control signals, the adder adds a beacon interval to the predetermined TBTT to set the next TBTT.

### BACKGROUND OF THE INVENTION

(A) Field of the Invention

The present invention relates to an apparatus for generating a control signal of a target beacon transmission time (TBTT) and method for the same, and more particularly, to an apparatus for generating the control signal of the TBTT and method for the same, which is implemented by an adder and a comparator.

(B) Description of Related Art

In order to operate correctly, all stations in a basic service set (BSS) of a wireless LAN should be in synchronization, and the so-called synchronization is that each station has the same clock. In fact, each station has its own clock, which may not be completely the same, and the clock difference will cause the deviation of time calculation. For example, when a master of a wireless LAN is transmitting a beacon frame, the stations have to receive it right on time. If the clock of the station is late, the station will miss the beacon frame and error may occur. According to the specification of the wireless LAN communication protocol IEEE 802.11, all stations shall maintain a local TSF timer, and a timing synchronization function (TSF) keeps the timer for all stations in the same BSS synchronized.

FIG. 1 is a schematic diagram showing an infrastructure wireless network 10 according to the prior art. As shown in FIG. 1, the infrastructure wireless network 10 comprises an access point (AP) 12 and three stations 14, 16 and 18. According to the specification of the wireless LAN communication protocol IEEE 802.11, the AP 12 shall be the timing master in the infrastructure wireless network 10 and shall perform the TSF. The AP 12 shall periodically transmit beacon frames that contain a copy of its TSF timer to synchronize the stations 14, 16 and 18. A receiving station shall always accept the timing information in beacon frames sent from the AP 12. If a station's TSF timer is different from the timestamp in the received beacon frame, the receiving station shall set its local timer to the received timestamp value.

FIG. 2 illustrates the format of a beacon frame 20 transmitted by the AP 12. As shown in FIG. 2, the beacon frame 20 comprises a timestamp field 22, a beacon interval field 24 and a service set identifier (SSID) field 26. The length of the timestamp segment 22 is 8 bytes, which records the TSF timer's time of the AP 12. The length of the beacon interval segment 24 is 2 bytes, which records the beacon interval of the beacon frame 20, wherein the beacon interval is the time interval between each TBTT. The SSID field 26 is used to record the identifier of the AP 12. At each TBTT, the AP 12 shall schedule a beacon as the next frame for transmission. Stations 14, 16 and 18 receive the beacon frame 20 and correct their own TSF timers according the value of the timestamp field 22. If the medium is determined to be unavailable, the AP shall delay the actual transmission of a beacon.

FIG. 3 is a schematic diagram showing an Ad hoc wireless network 30 according to the prior art. As shown in FIG. 3, the Ad hoc wireless network 30 includes four stations 32, 34, 36 and 38, wherein the station 32 is the timing master. The beacon interval is contained in beacon frames, and stations shall adopt that beacon interval when joining the Ad hoc wireless network 30. According to the specification of the wireless LAN communication protocol IEEE 802.11, stations 32, 34, 36 and 38 can become the timing master through competition, and each station maintains its own TSF timer that is used for timing. The timing master periodically transmits beacon frames that contain a copy of its TSF timer to synchronize the other stations, and the receiving station shall set its local timer to the received timestamp value.

The beacon interval usually is set to be 100 time units (TU), which is equivalent to 1024 microsecond. In the above-mentioned synchronization mechanism, the time controller needs an apparatus for generating the control signal of the TBTT that provides the control signal of the TBTT every 100 TUs according to the time of the TSF timer. In order to generate the control signal of the TBTT, the time of the TSF timer should be divided by 100 to calculate the TBTT. Because the TSF timer is a 64 bits timer, the prior art implements the above-mentioned calculation by a 64 bits divider to generate the control signal of the TBTT. However, the 64 bits divider requires very large chip area and the circuit design is also very complex.

### SUMMARY OF THE INVENTION

The objective of the present invention is to provide an apparatus and a method for generating the control signal of the target beacon transmission time (TBTT), which is implemented by an adder and a comparator.

In order to achieve the above-mentioned objective and avoid the problems of the prior art, the present invention provides an apparatus and a method for generating the control signal of the TBTT. The apparatus for generating the control signal of the TBTT is electrically connected to a host, and the host activates the apparatus by setting a predetermined TBTT. The apparatus for generating the control signal of the TBTT comprises a timing synchronous function (TSF) timer, a comparator electrically connected to the TSF timer, and an adder electrically connected to the comparator. The comparator compares the time of TSF timer and the predetermined TBTT, and generates the control signal of the TBTT if the comparison result is true. When the comparator generates the control signal, the adder adds a beacon interval to the predetermined TBTT to set the next TBTT.

The method for generating the control signal of the TBTT first reads the time of the TSF timer, and sets a predetermined TBTT. The method then compares whether the time of the TSF timer and the predetermined TBTT is equivalent. If the comparison result is false, the method continues to read the time of TSF timer and compares it with the predetermined TBTT. If the comparison result is true, the method generates the control signal of the TBTT, and sets the next TBTT by adding a beacon interval to the predetermined TBTT.

Compared with the prior art technology that faces the problems of design complexity and chip area requirement because of using the divider to generate the control signal of the TBTT, the present invention implements the apparatus and the method for generating the control signal of the TBTT by the adder and the comparator. As a result, the present invention can effectively reduce the chip area and the complexity of the integrated circuit design.

### BRIEF DESCRIPTION OF THE DRAWINGS

Other objectives and advantages of the present invention will become apparent upon reading the following description and upon reference to the accompanying drawings in which:

FIG. 1 is a schematic diagram showing an infrastructure wireless network according to the prior art;

FIG. 2 illustrates some important fields of a beacon frame broadcast by an access point;

FIG. 3 is a schematic diagram showing an Ad hoc wireless network according to the prior art;

FIG. 4 is a functional block diagram of an apparatus for generating the control signal of the TBTT according to the present invention; and

FIG. 5 is a flow chart of a method for generating the control signal of the TBTT according to the present invention.

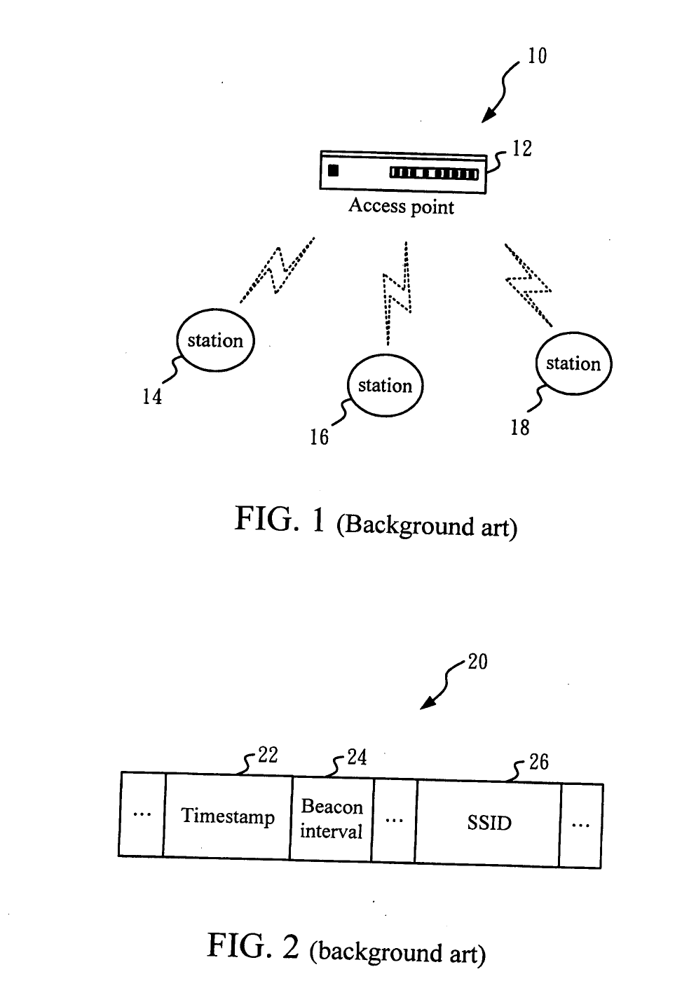

### DETAILED DESCRIPTION OF THE INVENTION

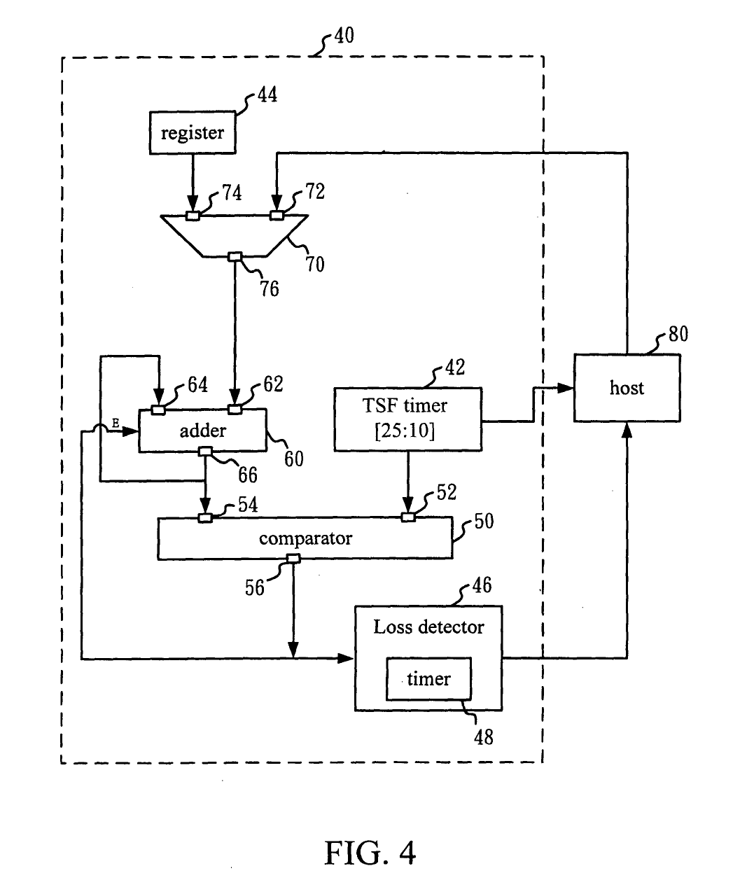

FIG. 4 is a functional block diagram of an apparatus 40 for generating the control signal of the TBTT according to the present invention. As shown in FIG. 4, the apparatus 40 for generating the control signal of the TBTT comprises a TSF timer 42, a comparator 50 electrically connected to the TSF timer 42, an adder 60 electrically connected to the comparator 50, a multiplexer 70 electrically connected to the adder 60 and a register 44 electrically connected to the multiplexer 70.

The apparatus 40 for generating the control signal of the TBTT is electrically connected to a host 80. The host 80 will send a first TBTT to activate the apparatus 40. The host 80 reads the time of the TSF timer 42 at first, and sets the first TBTT according to the time of the TSF timer 42. Then, the first TBTT is transmitted to the comparator 50 through the multiplexer 70 and the adder 60. The function of the TSF timer 42 is similar to a counter, and the increment action is carried out once per microsecond.

The multiplexer 70 comprises a first input port 72 electrically connected to the host 80, a second input port 74 electrically connected to the register 44 and an output port 76 electrically connected to the adder 60. The first input port 72 is used to receive the first TBTT from the host 80, and the register 44 is used to save the beacon interval value. At most times, the output port 76 of the multiplexer 70 outputs the beacon interval value stored in the register 44 to the adder 60, but outputs the TBTT to the adder 60 only when receiving the TBTT transmitted from the host 80.

The comparator 50 comprises a first input port 52 electrically connected to the TSF timer 42, a second input port 54 electrically connected to the adder 60 and an output port 56. The comparator 50 is used to compare the time of the TSF timer 42 with the TBTT transmitted from the adder 60. The first TBTT transmitted from the adder 60 is input to the comparator 50 through the second input port 54, and the comparator 50 continuously reads the time of TSF timer 42 through the first input port 52. The comparator 50 does not output any control signal corresponding to the TBTT through the output port 56, until the comparison result is equivalent.

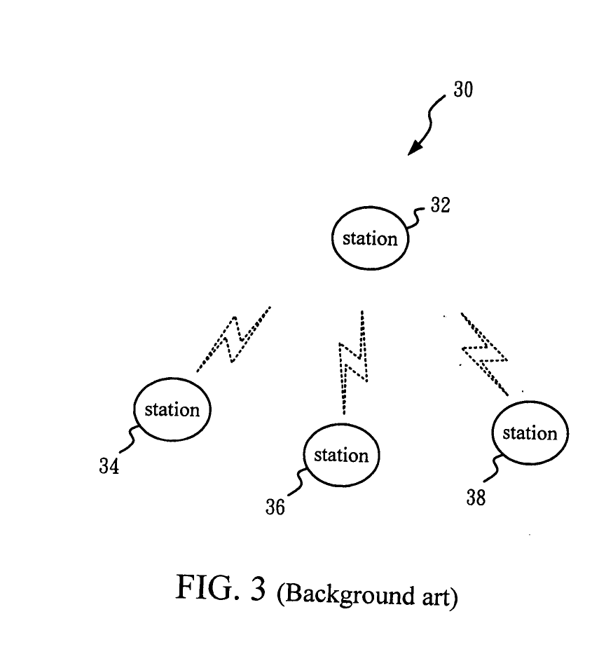

The adder 60 comprises a first input port 62 electrically connected to the multiplexer 70, an output port 66 electrically connected to the second input port 54 of the comparator 50, and a second input port 64 electrically connected to the output port 66. When the adder 60 receives the first TBTT transmitted from the host 80 through the first input port 62, it transmits the first TBTT to the comparator 50 through the output port 66 immediately. The comparator 50 will continuously compare the first TBTT from the adder 60 with the time of the TSF timer 42. If the comparison result is true, the comparator 50 will generate a control signal corresponding to the first TBTT and enable the arithmetic function of the adder (as shown in FIG. 3) so that the adder 60 adds a beacon interval to the arithmetic result of the previous period (i.e., the input value of second input port 64 from the output port 66) to form a second TBTT. The second TBTT is then transmitted to the comparator 50 through the output port 66 for the next period comparison.

After the comparator 50 receives the second TBTT from the adder 60 through the second input port 54, the comparator 50 continuously reads the time of the TSF time 42 to compare it with the second TBTT, and a control signal corresponding to the second TBTT will be generated when the comparison result of the comparator 50 is equivalent. The adder 60 will enable an arithmetic operation again according to the control signal to generate a third TBTT for the comparator 50. Through the operation cycle of the adder 60 and the comparator 50, the apparatus 40 can periodically generate the control signal of the TBTT.

The apparatus 40 of the present invention also comprises a loss detector 46 electrically connected to the output port 56 of the comparator 50 and the host 80, wherein the loss detector 46 includes a timer 48. If the loss detector 46 receives the control signal for a TBTT through the output port 56 of the comparator 50, the timer 48 will be set to zero. However, when the time of the timer 48 exceeds a predetermined value, a loss signal (such as interrupt signal) is output to the host 80.

Take for example that a predetermined value is two beacon intervals. If the loss detector 46 has not received any control signal from the TBTT during two beacon intervals, the timer 48 will exceed the predetermined value since the timer 48 is not set to be zero. Therefore, the loss detector 46 will send the loss signal to the host 80. When the host 80 receives the loss signal, it first reads the time of the TSF timer 42, and sets a new TBTT according to the time of the TSF timer 42 to activate the signal generator 40 again.

The host 80 must read the time of the TSF timer 42 at first when setting the TBTT, and then set a new TBTT that is later than the time of the TSF timer 42. Once the host 80 has set the new TBTT, the comparator 50 starts to compare the time of the TSF timer 42 with the new TBTT, and generate the control signal for the TBTT if the comparison result is the same. The new TBTT is later than the time of the TSF timer 42, and the size of the predetermined value is dependent on the bits of comparator 50. If the comparator 50 is designed as 16 bits, the maximum predetermined value can be set to be about 65,535 TUs. The time of the TSF time is recorded by 64 bits in microsecond, which can be expressed in time unit (TU) by reading from the tenth bit of the 64 bits. To check whether or not the time of the TSF timer is equal to the TBTT, the comparator 50 compares the 16 bits of TBTT with 16 bits (from the tenth to the twenty-fifth bit) of the TSF timer.

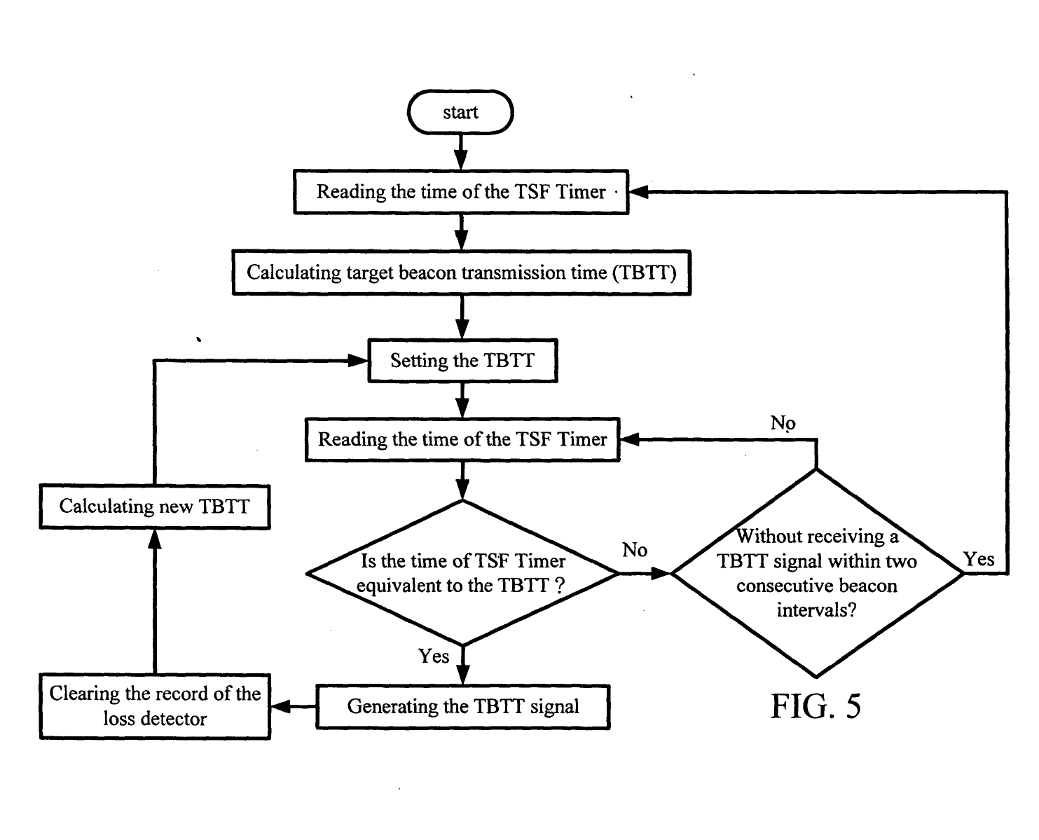

FIG. 5 is a flow chart of the method for generating a control signal of the TBTT according to the present invention. As shown in FIG. 5, the method reads the time of the TSF timer 42 at first and sets a predetermined TBTT according to the time of the TSF timer 42. A time comparison procedure is then performed after reading the time of the TSF timer 42. The time comparison procedure compares whether the time of TSF timer 42 is equivalent to the predetermined TBTT. If the time comparison result is true, the method generates the control signal for the TBTT, clears the record of loss detector 46, and calculates a new TBTT to set the next TBTT. After the next TBTT is set, the method reads the time of the TSF timer 42 again and performs the time comparison procedure.

If the result of the time comparison procedure result is false, a loss checking procedure is performed. The loss checking procedure checks if there is not a control signal of the TBTT generated within two consecutive beacon intervals. If the result of the loss checking procedure is false, the method continues to read the time of the TSF timer 42 and performs the time comparison procedure. If the result of the loss checking procedure is true, the method reads the time of the TSF timer, and sets a TBTT according to the time of the TSF timer to restart the operation flow shown in FIG. 5.

Compared with the prior art technology that faces the problems of design complexity and chip area requirement because of using the divider to generate the control signal of the TBTT, the present invention implements the apparatus and the method for generating the control signal of the TBTT by the adder and the comparator. As a result, the present invention can effectively reduce the chip area and the complexity of the integrated circuit design.

The above-described embodiments of the present invention are intended to be illustrative only. Numerous alternative embodiments may be devised by those skilled in the art without departing from the scope of the following claims.

What is claimed is:

1. An apparatus for generating a control signal of a target beacon transmission time, comprising:
a timing synchronization timer;
a comparator for comparing the time of the timing synchronization timer with a predetermined target beacon transmission time, and generating a control signal of the target beacon transmission time if the comparison is equivalent; and
an adder for setting the next target beacon transmission time by adding a beacon interval to the predetermined target beacon transmission time when the control signal of the target beacon transmission time is generated.

2. The apparatus for generating a control signal of a target beacon transmission time of claim 1, wherein the adder comprises an arithmetic enablement switch, which performs an addition operation when the control signal of the target beacon transmission time is generated.

3. The apparatus for generating a control signal of a target beacon transmission time of claim 1, wherein the adder comprises:
a first input port for receiving the predetermined target beacon transmission time;
an output port electrically connected to the comparator; and
a second input port electrically connected to the output port.

4. The apparatus for generating a control signal of a target beacon transmission time of claim 3, further comprising:
a register for storing the value of a beacon interval; and
a multiplexer electrically connected to the adder, including:
a first input port for receiving the predetermined target beacon transmission time;
a second input port electrically connected to the register; and
an output port electrically connected to the first input port of the adder.

5. The apparatus for generating a control signal of a target beacon transmission time of claim 1, further comprising a loss detector electrically connected to an output port of the comparator.

6. The apparatus for generating a control signal of a target beacon transmission time of claim 5, wherein the loss detector comprises a timer, and the loss detector resets the timer to zero when the control signal of the target beacon transmission time is received and generates a loss signal when the timer exceeds a predetermined time.

7. An apparatus for generating a control signal of a target beacon transmission time, electrically connected to a host setting a predetermined target beacon transmission time, the apparatus comprising:
a timing synchronization timer;
a comparator for comparing the time of the timing synchronization timer with the predetermined target beacon transmission time, and generating the control signal of the target beacon transmission time if the comparison is equivalent; and
an adder for setting the next target beacon transmission time by adding a beacon interval to the predetermined target beacon transmission time when the control signal of the target beacon transmission time is generated.

8. The apparatus for generating a control signal of a target beacon transmission time of claim 7, wherein the comparator comprises:
a first input port electrically connected to the timing synchronization timer;
a second input port electrically connected to the adder for receiving the predetermined target beacon transmission time; and
an output port for outputting the control signal of the target beacon transmission time.

9. The apparatus for generating a control signal of a target beacon transmission time of claim 8, wherein the adder comprises:
a first input port for receiving the predetermined target beacon transmission time;
an output port electrically connected to a second input port of the comparator for outputting the predetermined target beacon transmission time to the comparator; and
a second input port electrically connected to the output port.

10. The apparatus for generating a control signal of a target beacon transmission time of claim 9, further comprising a multiplexer electrically connected to the host and the adder, wherein the multiplexer comprises:
a first input port electrically connected to the host for receiving the predetermined target beacon transmission time;
a second input port electrically connected to a register storing the value of the beacon interval; and
an output port electrically connected to the first input port of the adder for outputting the predetermined target beacon transmission time to the adder.

11. The apparatus for generating a control signal of a target beacon transmission time of claim 7, further comprising a loss detector electrically connected to the output port of the comparator.

12. The apparatus for generating a control signal of a target beacon transmission time of claim 11, wherein the loss detector comprises a timer, and the loss detector resets the timer to zero when the control signal of the target beacon transmission time is received and generates a loss signal when the timer exceeds a predetermined time.

13. A method for generating a control signal of a target beacon transmission time, comprising the steps of:
setting a predetermined target beacon transmission time;
reading the time of a timing synchronization timer;
comparing the time of the timing synchronization timer with the predetermined target beacon transmission time; and
generating a control signal of the target beacon transmission time if the comparison is equivalent.

14. The method for generating a control signal of a target beacon transmission time of claim 13, further comprising the step of:
setting the next target beacon transmission time by adding a beacon interval to the predetermined target beacon transmission time when the comparison is equivalent.

15. The method for generating a control signal of a target beacon transmission time of claim 13, further comprising the step of:
resetting the predetermined target beacon transmission time if the control signal of the target beacon transmission time is not generated after a predetermined time.

16. The method for generating a control signal of a target beacon transmission time of claim 15, wherein the predetermined time is two beacon intervals.
